(19) United States
(12) Patent Application Publication
(10) Pub. No.: US 2017/0230440 A1
(43) Pub. Date: Aug. 10, 2017

(54) Transcoding and Control of Distribution of Assets as part of a Shared Workspace

(71) Applicant: Prysm, Inc., San Jose, CA (US)

(72) Inventors: Dino Cris Carlos, Fishers, IN (US); Adam P. Cuzzort, Westfield, IN (US); Andrew J. Weston, Indianapolis, IN (US)

(73) Assignee: Prysm, Inc., San Jose, CA (US)

(21) Appl. No.: 15/398,377

(22) Filed: Jan. 4, 2017

Related U.S. Application Data
(60) Provisional application No. 62/292,063, filed on Feb. 5, 2016.

(51) Int. Cl. H04L 29/06; H04L 12/28

(52) U.S. Cl. CPC H04L 65/607; H04L 12/2838; H04L 65/601; H04L 65/403; H04L 2012/285

(57) ABSTRACT

Techniques are described to transcode and control distribution of assets as part of a shared workspace. An asset is received for distribution as part of a shared workspace implemented using a plurality of appliances communicatively coupled, one to another, via a network. One or more settings are obtained that dictate which transformations are to be applied to the asset to form the plurality of versions of the asset. The asset is transcoded into a plurality of versions of the asset. Each of the plurality of versions has a difference, one to another, in a respective one of a plurality of characteristics of the asset. Distribution is controlled of the plurality of version of the asset as part of the shared workspace to the plurality of appliances.

### RELATED APPLICATIONS

This application claims priority to U.S. Provisional Patent Application No. 62/292,063, filed Feb. 5, 2016, and titled “Transcoding and Control of Distribution of Assets as part of a Shared Workspace,” the entire disclosure of which is hereby incorporated by reference.

### BACKGROUND

Shared workspaces may be implemented via a network to support a virtual environment in which users are able to share assets such as applications, content, video conferencing, annotations, and other media across a plurality of appliances. Shared workspaces thus enable users distributed over a variety of geographic locations to collaborate in real time to share thoughts and ideas.

Conventional techniques used to implement the shared workspace provide single and static assets for sharing. Different appliances that participate in the shared workspace, however, may have different characteristics in how the assets are consumed. The appliances, for instance, may have different resolutions, network connections having different amounts of bandwidth, and so forth. Accordingly, these differences may hinder an ability of the appliances to particular in a conventional shared workspace.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of a collaboration system operable to employ techniques described herein.

FIG. 2 is a conceptual diagram of a communication infrastructure of the collaboration system of FIG. 1 as sharing content streams across appliances.

FIG. 3 depicts a streaming infrastructure of FIG. 2 in greater detail.

FIG. 4 depicts a messaging infrastructure of FIG. 2 in greater detail.

FIG. 5 depicts a system in an example implementation in which transcoding is used to generated different versions of assets to be shared as part of a shared workspace, virtually.

FIG. 6 depicts a system in an example implementation in which versions of assets are created through transcoding performed by a transcoder module of FIG. 5.

FIG. 7 depicts a system in an example implementation showing distribution control of versions of content created as described in relation to FIG. 6.

FIG. 8 is a flow diagram depicting a procedure in an example implementation in which a plurality of versions of an asset shared as part of a shared workspace is generated.

FIG. 9 is a flow diagram depicting a procedure in an example implementation in which distribution is controlled of a plurality of versions of an asset shared as part of a shared workspace.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

Overview

Shared workspaces enable virtual collaboration of remote and locally connected appliances, such as tablet computers, wall displays, computing devices, mobile phones, and so forth. Accordingly, these appliances may support a variety of different functionality in how assets are consumed. Examples of assets include documents, images, video conferencing, and so forth as further described in the following. Accordingly, conventional techniques that limited sharing to static assets could limit an ability of these appliances to support real time collaboration and richness is display and interaction with the assets.

Techniques are described involving transcoding and control of distribution of assets as part of a shared workspace. For example, a plurality of appliances may be connected via a network to implement a shared workspace, virtually. These appliances may support a variety of different characteristics in consumption of content. Examples of such characteristics include resolution, image formats, document formats, network bandwidth, and so forth.

A large-format appliance configured to be mounted to a wall, for instance, may be feature rich and configured to support a high resolution, network bandwidth, and hardware resources such as memory and processing. A reduced-format appliance, such as a tablet or mobile phone configured to be held by one or more hands of a user, however, may have reduced resolution, network bandwidth, and hardware resources when compared to the large-format appliance. Accordingly, how the asset is consumed by the large-format device may differ from consumption on the reduced-format device.

Accordingly, techniques are described in which different versions of an asset are shared as part of shared workspace are generated and distribution of which is controlled based on characteristics of the appliances that are to consume to consume the asset. The versions of the asset, for instance, may vary in resolution, image format, document format, streaming protocol used to communicate the asset, and so forth. When requesting access to an asset as part of the shared workspace, a handshaking process is performed to determine which version of the asset is to be communicated to the requesting appliance. Thus, each appliance may obtain a version of the asset tailored to functionality of that appliance. In this way, efficient communication is provided to enable real time performance of the shared workspace, further discussion of which is described in the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

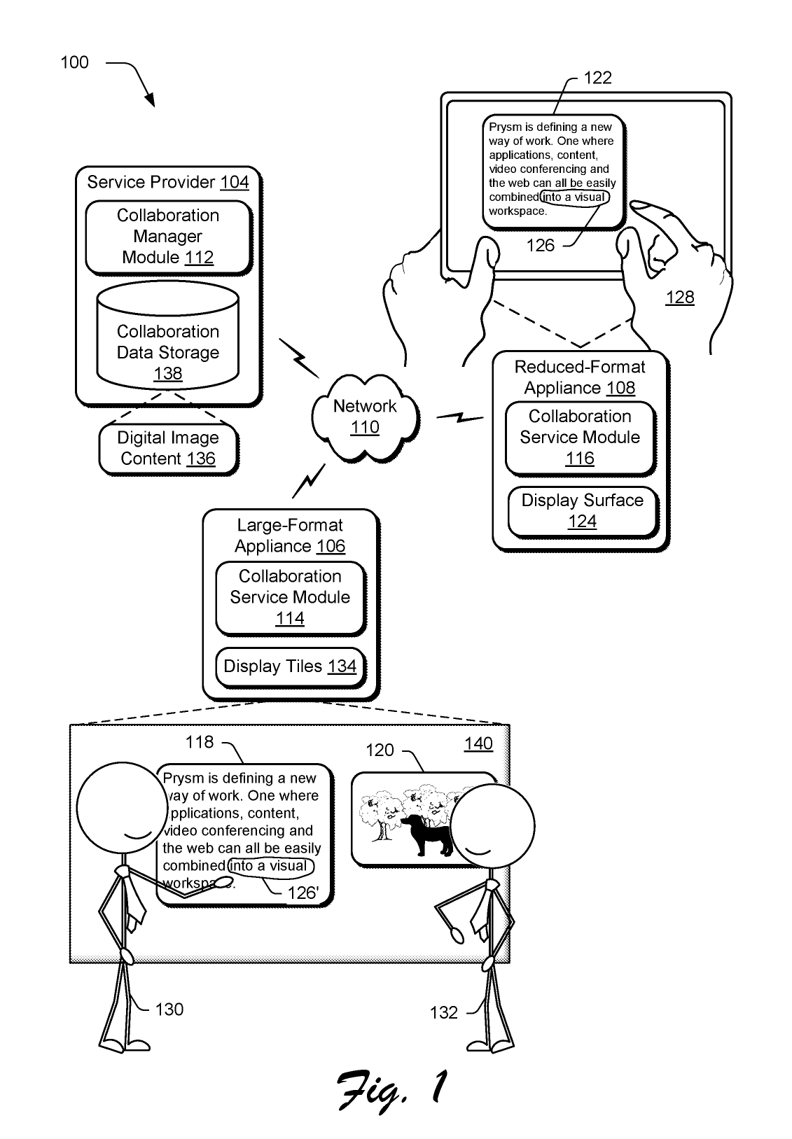

FIG. 1 is an illustration of a collaboration system 100 in an example implementation that is configured to implement one or more aspects of the techniques described herein. As shown, collaboration system 100 includes, without limitation, a service provider 104 and appliances that are used to implement a shared workspace, illustrated examples of which include a large-format appliance 106 and a reduced-format appliance 108, each of which are communicatively coupled via a network 110. The large-format appliance 106 is one that has a physically self-supporting display (e.g., greater than 35 inches diagonal) with rich hardware resources including processing, memory, or network resources, which may support simultaneous interaction with a plurality of users as illustrated. The reduced-format appliance 108, on the other hand, has a housing configured to be held by one or more hands of a user or placed on a surface (e.g., as a display device of a personal computer) and may have reduced processing, memory, and network resources in comparison to the large-format appliance 106, which support single user interaction due to this size. Although large and reduced format appliances 106, 108 are described in relation to the following examples, it should be readily apparent that a plurality of appliances may be made up of appliances that support large or reduced formats, solely.

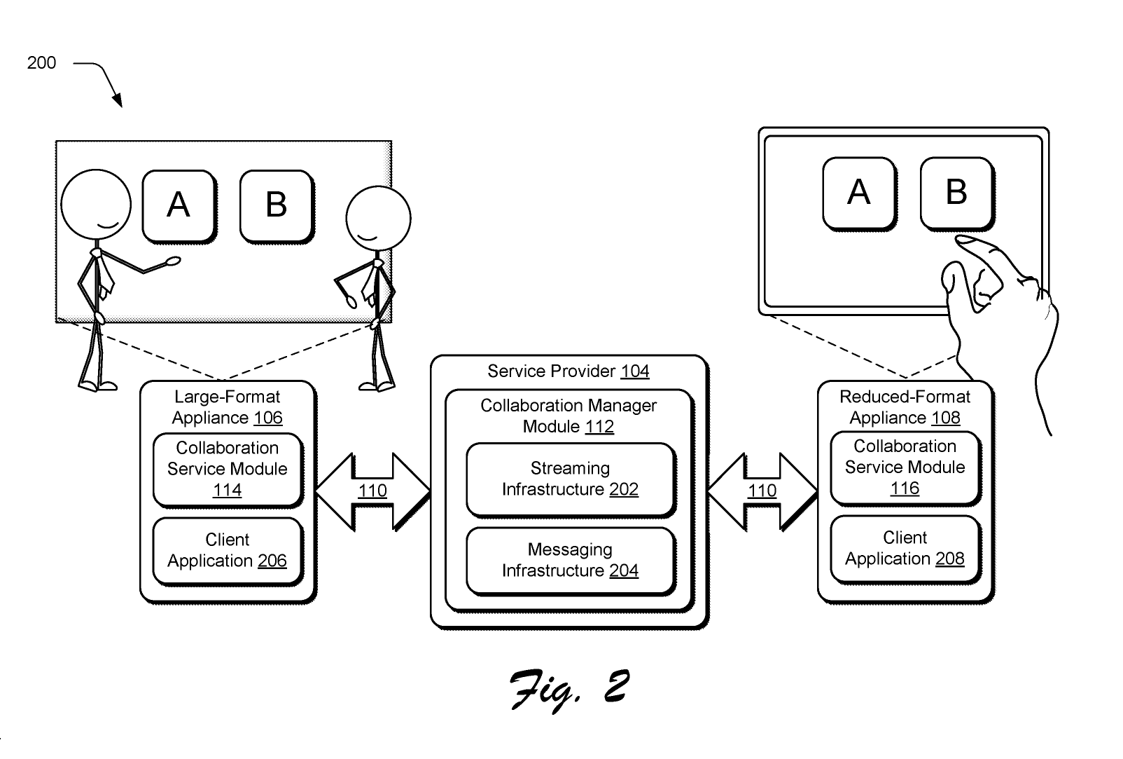

The service provider 104 is illustrated as including a collaboration manager module 112 and the appliances are illustrated as including respective collaboration service modules 114, 116 that together are representative of functionality implemented at least partially in hardware to support a shared workspace of a collaborative environment as further described in the following. Collaboration service modules 114, 116, for instance, may be configured as software such as applications, third-party plug-in modules, webpages, web applications, web platforms, and so on that support participation as part of a shared workspace. The collaboration manager module 112 is representative of functionality (e.g., implemented via software) that is usable to manage this interaction, examples of which are further described in relation to FIGS. 2-4. Although illustrated separately, functionality of the collaboration manager module 112 to manage the shared workspace may also be incorporated by the appliances themselves.

The collaboration service modules 114, 116, for instance, may be implemented as part of a web platform that work works in connection with network content, e.g. public content available via the “web,” to implement a shared workspace. A web platform can include and make use of many different types of technologies such as, by way of example and not limitation, URLs, HTTP, REST, HTML, CSS, JavaScript, DOM, and the like. The web platform can also work with a variety of data formats such as XML, JSON, and the like. Web platform can include various web browsers, web applications (i.e. “web apps”), and the like. When executed, the web platform allows a respective appliance to retrieve assets (e.g., web content) such as electronic documents in the form of webpages (or other forms of electronic documents, such as a document file, XML file, PDF file, XLS file, etc.) from a Web server (e.g., the service provider) for display on a display device in conjunction with the shared workspace.

The shared workspace is configured to share asset and user interactions with those assets. In the context of this disclosure, an “asset” may refer to any interactive renderable content that can be displayed on a display, such as on a display device of the large-format appliance 106 or reduced-format appliance 108, among others. Interactive renderable content is generally derived from one or more persistent or non-persistent content streams that include sequential frames of video data, corresponding audio data, metadata, flowable/reflowable unstructured content, and potentially other types of data.

Generally, an asset may be displayed within a dynamically adjustable presentation window. An example of this is illustrated presentation windows 118, 120 for the large-format appliance 106 and presentation window 122 as displayed for the reduced-format appliance 108. For simplicity, an asset and corresponding dynamically adjustable presentation window are generally referred to herein as a single entity, i.e., an “asset.” Assets may comprise content sources that are file-based, web-based, or Live Source. Assets may include images, videos, web pages, documents, renderings of laptop screens, presentation slides, any other graphical user interface (GUI) of a software application, and the like.

An asset generally includes at least one display output generated by a software application, such as a GUI of the software application. In one example, the display output is a portion of a content stream. In addition, an asset is generally configured to receive one or more software application inputs. The reduced-format appliance 108, for instance, may include a display surface 124 having gesture detection functionality (e.g., a touch sensitive display device, a display device associated with one or more cameras configured to capture a natural user input, and so forth) to capture a gesture, such as an annotation 126 to circle text in a document made by one or more fingers of a user's hand 128. The annotation is then communicated and displayed on the large-format applicant 106 as annotation 126′ that also circles corresponding text in a presentation window 118 that is viewable by users 130, 132 of that appliance. Thus, unlike a fixed image, an asset is a dynamic element that enables interaction with the software application associated with the asset, for example, for manipulation of the asset. For example, an asset may include select buttons, pull-down menus, control sliders, and so forth that are associated with the software application and can provide inputs to the software application.

As also referred to herein, a “shared workspace” is a virtual digital canvas on which assets associated therewith, and their corresponding content streams, are displayed within a suitable dynamic “viewport window”. Thus, a shared workspace may comprise one or more associated assets (each asset displayed within a presentation window), whereby the entire shared workspace is displayed within a dynamically adjustable viewport window. A shared workspace may be displayed in the entire potential render area/space of a display device of the large-format appliance 106 and/or the reduced-format appliance 108, so that only a single shared workspace can be displayed on the surface thereof. In this case, the area of the viewport window that displays the shared workspace comprises the entire render area of the large-format appliance 106 and/or the reduced-format appliance 108. In other implementations, however, the shared workspace and the viewport window may be displayed in a sub-area of the total display area of the large-format appliance 106 and/or the reduced-format appliance 108 that does not comprise the entire render area of respective display devices of these appliances. For example, multiple shared workspaces may be displayed in multiple viewport windows on the large-format appliance 106 and/or the reduced-format appliance 108 concurrently, whereby each shared workspace and viewport window does not correspond to the entire display surface. Each asset associated with a shared workspace, and content stream(s) corresponding to the asset, are displayed in a presentation window according to defined dimensions (height and width) and a location within the shared workspace and viewport window. The asset and presentation window dimensions and location may also be user-adjustable. As also referred to herein, a “project” may comprise a set of one or more related shared workspaces.

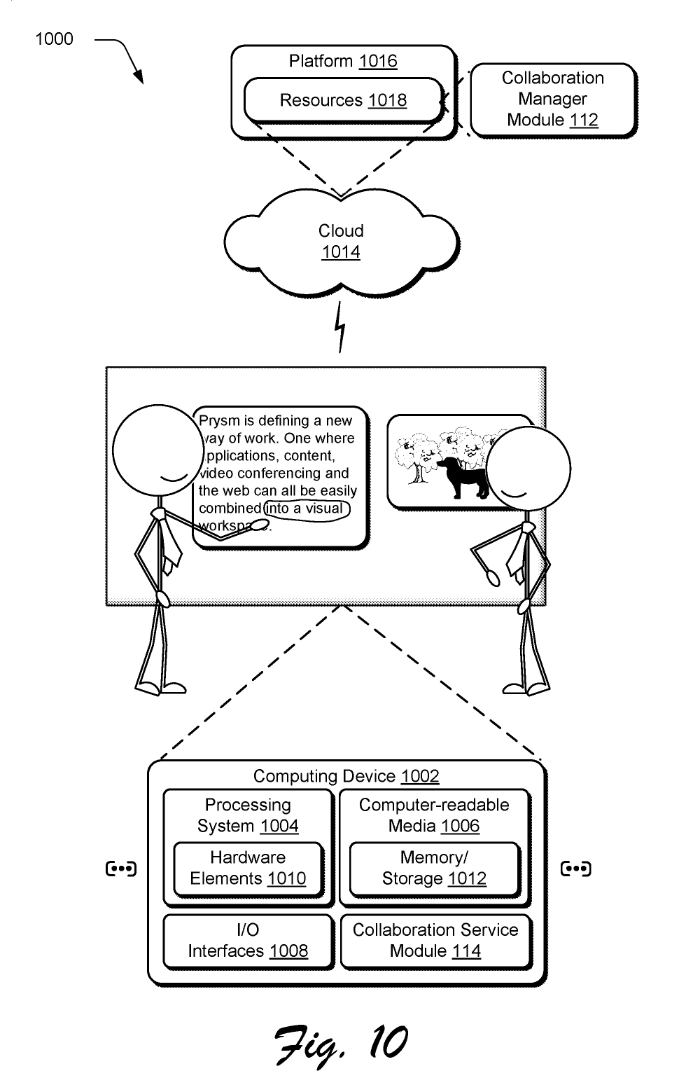

The large-format appliance 106 in this example is formed using a plurality of display tiles 134, e.g., arranged to form a display wall. The service provider 104 includes digital image content 136, which is illustrated as stored in collaboration data storage 136, e.g., using one or more memory devices as further described in relation to FIG. 10. The service provider 104 may receive this digital image content 136 from a variety of sources, such as the reduced-format appliance 108, the large-format appliance 106, remotely via a third-party source via the network 110 (e.g., a website), or from an information network or other data routing device, and converts said input into image data signals. Thus, digital image content 136 may be generated locally, with the large-format appliance 106 or the reduced-format appliance 108, or from some other location. For example, when the collaboration system 100 is used for remote conferencing, digital image content 136 may be received via any technically feasible communications or information network, wired or wireless, that allows data exchange, such as a wide area network (WAN), a local area network (LAN), a wireless (Wi-Fi) network, and/or the Internet, among others as represented by network 110. The service provider 104, reduced-format appliance 108, and large-format appliance 106 may be implemented as one of more computing devices, such as part of dedicated computers, as one or more servers of a server farm (e.g., for the service provider 104 as implementing one or more web services), dedicated integrated circuit, and so on. These computing devices are configured to maintain instructions in computer-readable media and that are executable by a processing system to perform one or more operations as further described in relation to FIG. 10.

Display devices of the large-format appliance 106 and/or the reduced-format appliance 108 may include the display surface or surfaces of any technically feasible display device or system type, including but not limited to the display surface of a light-emitting diode (LED) display, a digital light (DLP) or other projection displays, a liquid crystal display (LCD), optical light emitting diode display (OLED), laser-phosphor display (LPD) and/or a stereo 3D display all arranged as a single stand-alone display, head mounted display or as a single or multi-screen tiled array of displays. Display sizes may range from smaller handheld or head mounted display devices to full wall displays. In the example illustrated in FIG. 1, the large-format appliance 106 includes a plurality of display light engine and screen tiles mounted in an array, which are represented by the display tiles 134.

In operation, the large-format appliance 106 displays image data signals received from the service provider 104. For a tiled display, image data signals 102 are appropriately distributed among display tiles 134 such that a coherent image is displayed on a display surface 138 of the large-format appliance 106. Display surface 140 typically includes the combined display surfaces of display tiles 134. In addition, the display surface 138 of large-format appliance 106 is touch-sensitive that extends across part or all surface area of display tiles 134. In one implementation, the display surface 140 senses touch by detecting interference between a user and one or more beams of light, including, e.g., infrared laser beams. In other implementations, display surface 140 may rely on capacitive touch techniques, including surface capacitance, projected capacitance, or mutual capacitance, as well as optical techniques (e.g., sensor in a pixel), acoustic wave-based touch detection, resistive touch approaches, and so forth, without limitation and thus may detect “touch” inputs that do not involve actual physical contact, e.g., as part of a natural user interface. Touch sensitivity of the display surface 138 enables users to interact with assets displayed on the wall implementing touch gestures including tapping, dragging, swiping, and pinching. These touch gestures may replace or supplement the use of typical peripheral I/O devices, although the display surface 140 may receive inputs from such devices, as well. In this regard, the large-format appliance 106 may also include typical peripheral I/O devices (not shown), such as an external keyboard or mouse.

The display surface 140 may be a “multi-touch” surface, which can recognize more than one point of contact on the large-format appliance 106, enabling the recognition of complex gestures, such as two or three-finger swipes, pinch gestures, and rotation gestures as well as multiuser two, four, six etc. hands touch or gestures. Thus, a plurality of users 130, 132 may interact with assets on the display surface 140 implementing touch gestures such as dragging to reposition assets on the screen, tapping assets to display menu options, swiping to page through assets, or implementing pinch gestures to resize assets. Multiple users 130, 132 may also interact with assets on the screen simultaneously. Again, examples of assets include application environments, images, videos, web pages, documents, mirroring or renderings of laptop screens, presentation slides, content streams, and so forth. Touch signals are sent from the display surface 140 to the service provider 104 for processing and interpretation. It will be appreciated that the system shown herein is illustrative only and that variations and modifications are possible.

FIG. 2 is a conceptual diagram of a communication infrastructure 200 of the collaboration system 100 of FIG. 1 as sharing content streams across appliances, e.g., across the large and reduced format appliances 106, 108 through interaction with the service provider 104. As shown, this communication infrastructure 200 includes, without limitation, the large-format appliance 106 and the reduced-format appliance 108 communicatively coupled to service provider 104 via a network 110. As shown in FIG. 2, communication infrastructure 200 of this example implementation includes streaming infrastructure 202 and messaging infrastructure 204 included as part of the collaboration manager module 112 to support communication of the collaboration service modules 114, 116 to implement the shared workspace.

Large-format appliance 106 is illustrated as sharing a content stream A, via communication infrastructure 200, with the reduced-format appliance 108. In response, reduced-format appliance 108 is configured to retrieve content stream A from communication infrastructure 200 and to display that content stream on a display device of the reduced-format appliance 108 with its content stream B. Likewise, reduced-format appliance 108 is configured to share content stream B, via communication infrastructure 200, with the large-format appliance 106. In response, the large-format appliance 106 is configured to retrieve content stream B from communication infrastructure 200 and to display that content stream on a display device of the large-format appliance 106 with its content stream A.

In this fashion, the large and reduced format appliances 106, 108 are configured to coordinate with one another via the service provider 104 to generate a shared workspace that includes content streams A and B. Content streams A and B may be used to generate different assets rendered within the shared workspace. In one embodiment, each of the large and reduced format appliances 106, 108 perform a similar process to reconstruct the shared workspace, thereby generating a local version of that shared workspace that is similar to other local versions of the shared workspace reconstructed at other appliances. As a general matter, the functionality of the large and reduced format appliances 106, 108 are coordinated by respective collaboration service modules 114, 116 and client applications 206, 208, respectively.

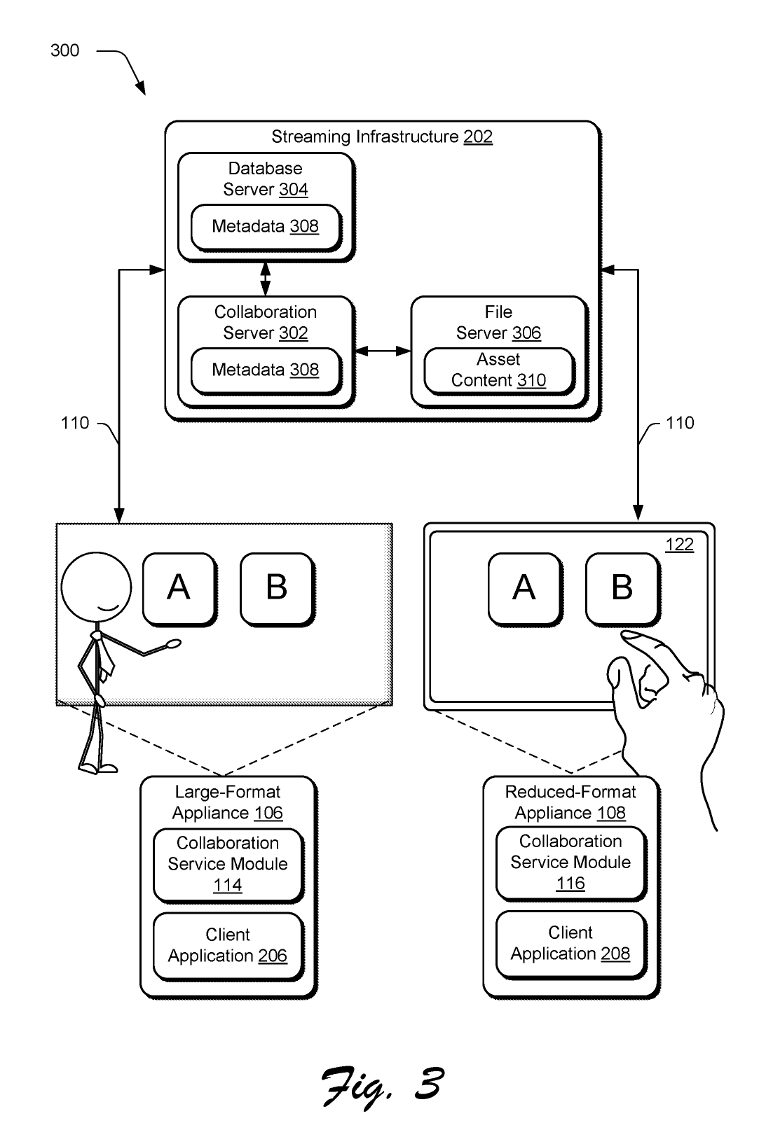

Client applications 206, 208 are software programs that generally reside within a memory (as further described in relation to FIG. 10) associated with the respective appliances. Client applications 206, 208 may be executed by a processing system included within the respective appliances. When executed, client applications 206, 208 setup and manage the shared workspace discussed above in conjunction with FIG. 2, which, again, includes content streams A and B. In one implementation, the shared workspace is defined by metadata that is accessible by both the large and reduced format appliances 106, 108. Each of the large and reduced format appliances 106, 108 may generate a local version of the shared workspace that is substantially synchronized with the other local version, based on that metadata (discussed below in relation to FIG. 3).

In doing so, client application 206 is configured to transmit content stream A to streaming infrastructure 200 for subsequent streaming to the reduced-format appliance 108. Client application 206 also transmits a message to the reduced-format appliance 108, via messaging infrastructure 204, that indicates to the large-format appliance 106 that content stream A is available and can be accessed at a location reflected in the message. In like fashion, client application 208 is configured to transmit content stream B to streaming infrastructure 202 for subsequent streaming to the large-format appliance 106. Client application 208 also transmits a message to the large-format appliance 106, via messaging infrastructure 204, that indicates to the large-format appliance 106 that content stream B is available and can be accessed at a location reflected in the message. The message indicates that access may occur from a location within streaming infrastructure 202.

Client application 206 may also broadcast a message via messaging infrastructure 204 to the reduced-format appliance 108 that specifies various attributes associated with content stream A that may be used to display content stream A. The attributes may include a location/position, a picture size, an aspect ratio, or a resolution with which to display content stream A on the reduced-format appliance 108, among others, and may be included within metadata described below in relation to FIG. 3. Client application 208 may extract the attributes from messaging infrastructure 204, and then display content stream A at a particular position on a display device of the reduced-format appliance 108, with a specific picture size, aspect ratio, and resolution, as provided by messaging infrastructure 204. Through this technique, the large-format appliance 106 is capable of sharing content stream A with the reduced-format appliance 108. The reduced-format appliance 108 is also configured to perform a complimentary technique in order to share content stream B with the large-format appliance 106.

Client applications 206, 208 are thus configured to perform similar techniques in order to share content streams A and B, respectively with one another. When client application 206 renders content stream A on a display device of the large-format appliance 106 and, also, streams content stream B from streaming infrastructure 202, the large-format appliance 106 thus constructs a version of a shared workspace that includes content stream A and B. Similarly, when client application 208 renders content stream B on a display device of the reduced-format appliance 108 and, also streams content stream A from streaming infrastructure 202, the large-format appliance 106 similarly constructs a version of that shared workspace that includes content streams A and B.

The appliances (e.g., the large and reduced format appliances 106, 108) discussed herein are generally coupled together via streaming infrastructure 202 and messaging infrastructure 204. Each of these different infrastructures may include hardware that is cloud-based and/or co-located on-premises with the various appliance, which are both represented by network 110. However, persons skilled in the art will recognize that a wide variety of different approaches may be implemented to stream content streams and transport messages/messages between display systems.

FIG. 3 depicts a block diagram 300 showing the streaming infrastructure 202 of FIG. 2 in greater detail. Streaming infrastructure 202 in this example includes a collaboration server 302, a database server 304, and a file server 306. Each server may comprise a computer device having a processor (such as processing system unit described in relation to FIG. 10) and a computer-readable medium such as memory, the processor executing software for performing functions and operations described herein. Collaboration server 302, database server 304, and file server 306 may be implemented as shown as separate and distinct computing devices/structures coupled to each other and to the appliances via a network 110. Alternatively, functionality of collaboration server 302, database server 304, and file server 306 may be implemented as a single computing device/structure in a single location (e.g., logically or virtually), or in any other technically feasible combination of structures. Further, one or more of collaboration server 302, database server 304, and/or file server 306 may be implemented as a distributed computing system. The network 110 may be via any technically feasible communications or information network, wired or wireless, that allows data exchange, such as a wide area network (WAN), a local area network (LAN), a wireless (WiFi) network, and/or the Internet, among others.

Collaboration server 302 coordinates the flow of information between the various appliances (e.g., the large and reduced format appliances 106, 108), database server 304, and file server 306. Thus, in some implementations, collaboration server 302 is a streaming server for the appliances. In some embodiments, the application program interface (API) endpoint for the appliances and/or business logic associated with streaming infrastructure 202 resides in collaboration server 302. In addition, collaboration server 302 receives requests from appliances and can send notifications to the appliances. Therefore, there is generally a two-way connection between collaboration server 302 and each of appliances, e.g., the large and reduced format appliances 106, 108. Alternatively or additionally, appliances may make requests on collaboration server 302 through the API. For example, during collaborative work on a particular project via collaboration system 100, an appliance may send a request to collaboration server 302 for information associated with an asset to display the asset in a shared workspace of the particular project.

Database server 304 (as well as collaboration server 302) may store metadata 308 associated with collaboration system 200, such as metadata for specific assets, shared workspaces, and/or projects. For example, such metadata may include which assets are associated with a particular shared workspace, which shared workspaces are associated with a particular project, the state of various settings for each shared workspace, annotations made to specific assets, etc. Metadata 308 may also include aspect ratio metadata and asset metadata for each asset. In some implementations, aspect ratio metadata may include an aspect ratio assigned to the project (referred to herein as the “assigned aspect ratio”). An aspect ratio assigned to a project applies to the shared workspaces of the project so that all shared workspaces of the project have the same aspect ratio assigned to the project. Asset metadata for an asset may specify a location/position and dimensions/size of the asset within an associated shared workspace.

The asset metadata indicates the position and size of an asset, for example, implementing horizontal and vertical (x and y) coordinate values. In some embodiments, the asset metadata may express the position and size of an asset in percentage values. In such implementations, the size (width and height) and position (x, y) of the asset is represented in terms of percent locations along an x-axis (horizontal axis) and y-axis (vertical axis) of the associated shared workspace. For example, the position and size of an asset may be expressed as percentages of the shared workspace width and shared workspace height. The horizontal and vertical (x and y) coordinate values may correspond to a predetermined point on the asset, such as the position of the upper left corner of the asset. Thus, when display surfaces of appliances have different sizes and/or aspect ratios, each asset can still be positioned and sized proportional to the specific shared workspace in which is it being displayed. When multiple display devices of multiple appliances separately display a shared workspace, each may configure the local version of the shared workspace based on the received metadata.

File server 306 is the physical storage location for some or all asset content 310 that are rendered as files, such as documents, images, and videos. In some embodiments, file server 306 can receive requests for asset content 310 directly from appliances. For example, an asset, such as a word-processing document, may be associated with a shared workspace that is displayed on a display device of a plurality of appliances, e.g., the large and reduced format appliances 106, 108. When the asset is modified by a user at the large-format appliance 106, metadata for a file associated with the asset is updated in file server 306 by collaboration server 302, the reduced-format appliance 108 downloads the updated metadata for the file from file server 306, and the asset is then displayed, as updated, on the gesture-sensitive display surface 124 of the reduced-format appliance 108. Thus, file copies of all assets for a particular shared workspace and project may be stored at the file server 306, as well as stored at each appliance that is collaborating on a project.

Each of appliances is an instance of a collaborative multi-media platform disposed at a different location in a collaboration system 100. Each collaboration appliance is configured to provide a digital system that can be mirrored at one or more additional and remotely located appliances. Thus, collaboration clients facilitate the collaborative modification of assets, shared workspaces, and/or complete presentations or other projects, as well as the presentation thereof.

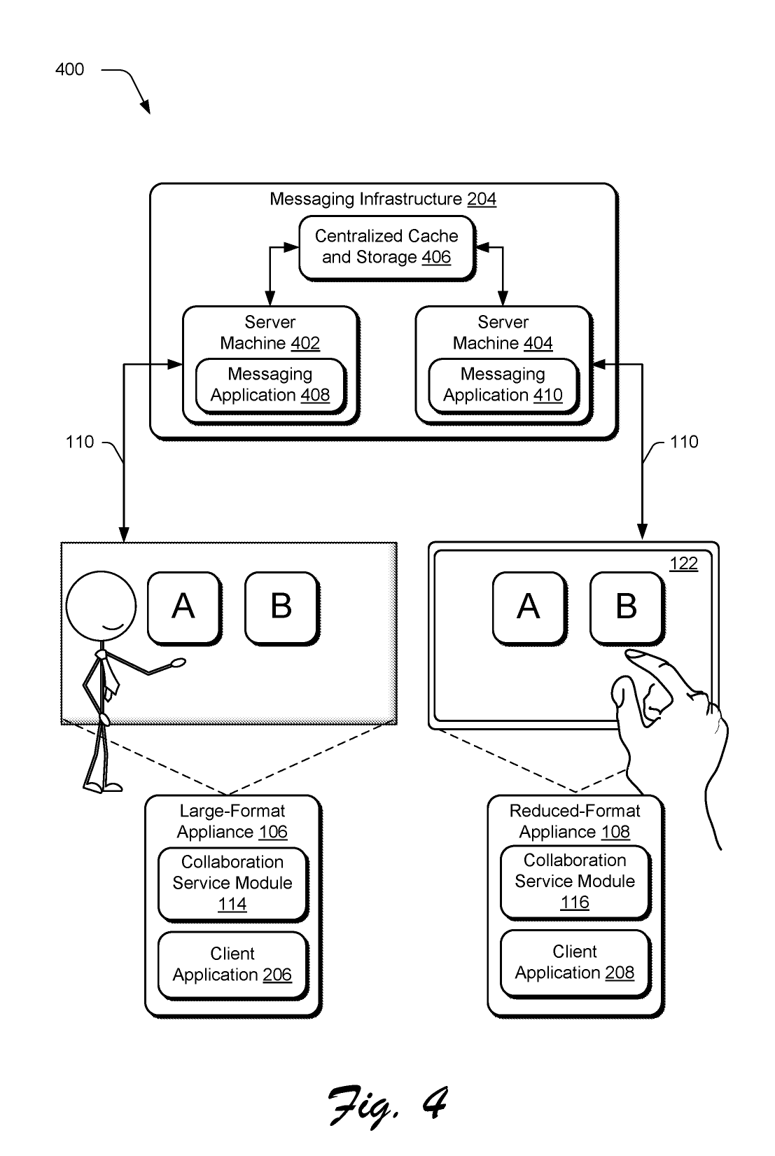

FIG. 4 depicts the messaging infrastructure 204 of FIG. 2 in greater detail. As shown, messaging infrastructure 204 includes server machines 402 and 404 coupled together via centralized cache and storage 406. Server machine 402 is coupled to the large-format appliance 106 and includes a messaging application 408. Server machine 404 is coupled to the reduced-format appliance 108 and includes a messaging application 410.

Server machines 402 and 404 are generally cloud-based or on-premises computing devices that include memory and processing systems as further described in relation to FIG. 10 configured to store and execute messaging applications 408 and 410, respectively. Messaging applications 408 and 410 are configured to generate real-time socket connections with the large and reduced format appliances 106, 108, respectively, to allow messages to be transported quickly between the appliances. In one implementation, messaging applications 408 and 410 are implemented as ASP.NET applications and rely on signalR WebSockets to accomplish fast, real-time messaging.

Centralized cache and storage 406 provides a persistent messaging back-end through which messages can be exchanged between messaging applications 408 and 410. In one embodiment, centralized cache and storage includes a Redis cache backed by a SQL database. Messaging applications 408 and 410 may be configured to periodically poll centralized cache and storage 406 for new messages, thereby allowing messages to be delivered to those applications quickly.

In operation, when the large-format appliance 106 transmits a message indicating that content stream A is available on streaming infrastructure 202, as described above, the large-format appliance 106 transmits that message to messaging application 408. Messaging application 408 may then relay the message to centralized cache and storage 406. Messaging application 410 polls centralized cache and storage 406 periodically, and may thus determine that that the message has arrived. Messaging application 410 then relays the message to the reduced-format appliance 108. The reduced-format appliance 108 may then parse the message to retrieve an identifier associated with the large-format appliance 106, and then stream content associated with the large-format appliance 106 from streaming infrastructure 202.

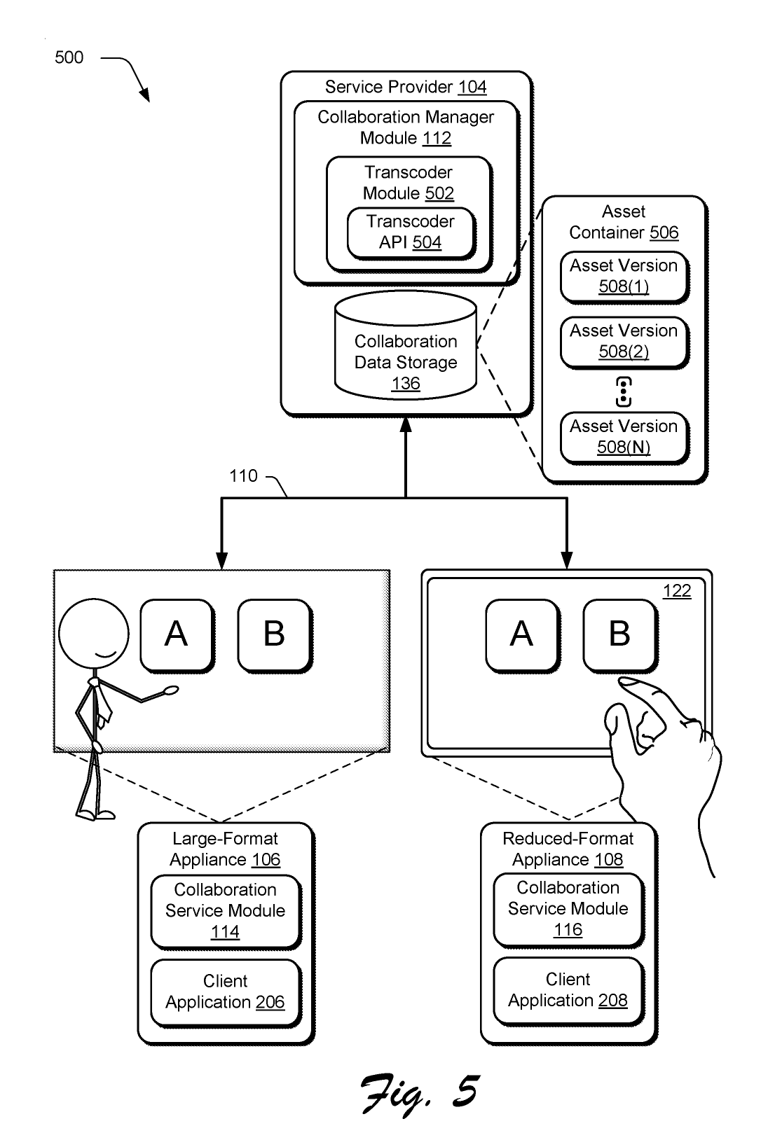

FIG. 5 depicts a system 500 in an example implementation in which transcoding is used to generated different versions of assets to be shared as part of a shared workspace, virtually. The system 500 includes large and reduced format appliances 106, 108 as previously described, which are examples of some of a variety of different types of appliances that are configured to particular in a shared workspace with other types also contemplated, such as desktop computers, smart televisions, and so forth.

The service provider 104 may be implemented in a variety of ways, such as via a platform “over the cloud” as described in relation to FIG. 10, as part of the large or reduced format appliances 106, 108, and so forth. The service provider 104 includes a collaboration manager module 112 that is representative of functionality to manager a shared workspace, virtually. As part of this shared workspace, assets may be shared. Assets may include content sources that are file-based, web-based, or Live Source. Assets may include images, videos, web pages, documents, renderings of laptop screens, presentation slides, any other graphical user interface (GUI) of a software application, and the like.

The collaboration manager module 112 is illustrated as including a transcoder module 502 and associated transcoder application programming interface (API) 504. The transcoder module 502 is representative of functionality implemented at least partially in hardware to transcode assets to form a variety of versions of the asset to be shared as part of the shared workspace. An example of this is illustrated as an asset container 506 that includes a plurality of asset versions, e.g., asset version 508(1), asset version 508(2), through asset version 508(N). Each of these versions has a difference, one to another, in a respective one of a plurality of characteristics of the asset, such as resolution, formats, and so forth as described in the following. In this way, the collaboration manager module 112 may then control distribution of the asset versions 508(1)-508(N) as appropriate, such as to address differences in functionality used to consume the assets by the large and reduced format appliances 106, 108 as further described in the following.

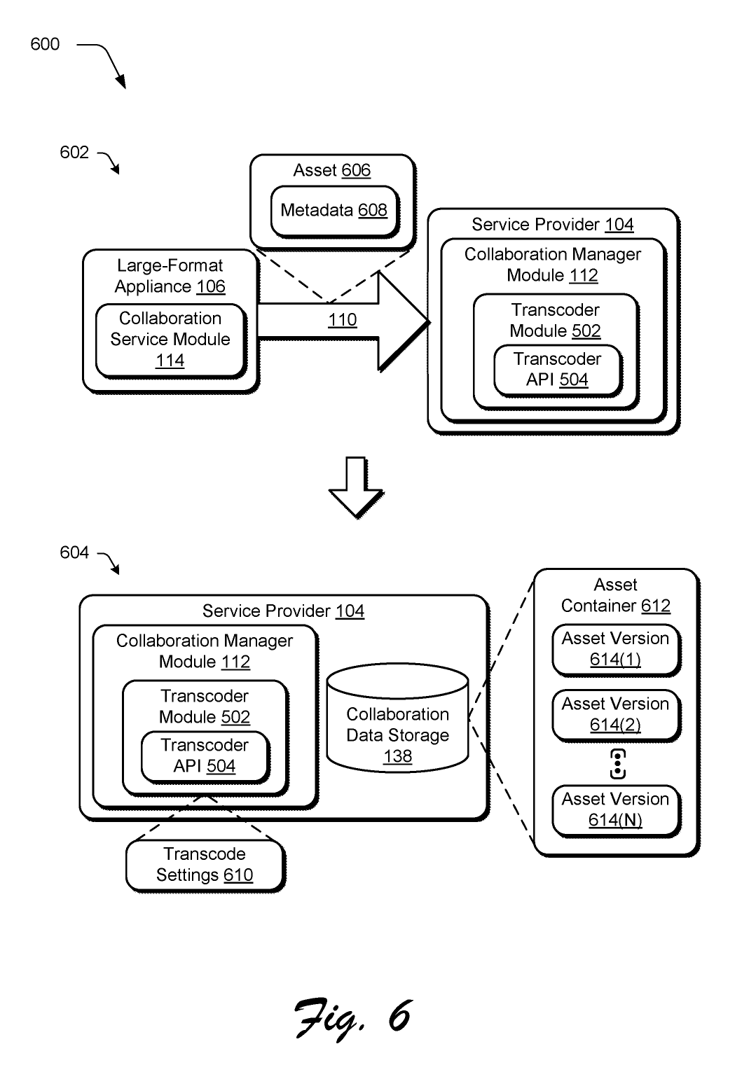

FIG. 6 depicts a system 600 in an example implementation in which versions of assets are created through transcoding performed by the transcoder module 502 of FIG. 5. This example is illustrated using first and second stages 602, 604, and may be performed by a variety of systems, such as the collaboration server 302 of FIG. 3.

At the first stage 602, an asset 606 and associated metadata 608 is received by the service provider 104 from a large-format appliance 106 over a network 110, although any other appliance type is also contemplated. The asset 606 may be received before, after, or during a shared workspace session (e.g., for use in a subsequent session). As previously described, the asset 606 may assume a variety of types of configurations, which may be detailed by the associated metadata 608, such as content type, resolution, and so forth. The asset 606 and associated metadata 608 are received in this example via a transcoder API 504 of the transcoder module 502.

At the second stage 604, the transcoder module 502 transcodes the asset 606 into a plurality of versions. For example, the transcoder module 502 may first examine the metadata 608 associated with the asset 606 to determine characteristics of the asset, such as format, resolution, and so forth. From this, the transcoder module 502 obtains transcode settings 610 that detail which versions of the asset 606 are to be generated based on these characteristics. For example, a plurality of resolution may be categorized by width in pixels, such as small (e.g., 200), medium (e.g., 768), and large (e.g., 1300). Image formats may also be specified, such as “.png.” “.jpg,” “.jpeg,” “.gif,” “.bmp” and so forth. Document formats may also be specified, such as presentation (e.g., “.ppt,” “.pptx”), word processing (e.g., “.doc.,” “.docx”), spreadsheet (e.g., .xls, “.xlsx”), and so forth. In compliance with H264, for instance, different bit-resolutions versions may also be stored. This may be triggered (e.g., immediately) without user intervention upon upload of the asset, responsive to selection made by a user, and so forth. In this way, an asset container 612 may be formed have a plurality of asset versions 614(1), 614(2), . . . , 614(N) of a single asset for distribution to appliances based on characteristics of those clients. Further, as these versions may be precomputed, this may further support real time interaction as part of the shared workspace. An example of distribution control is described in the following and shown in a corresponding figure.

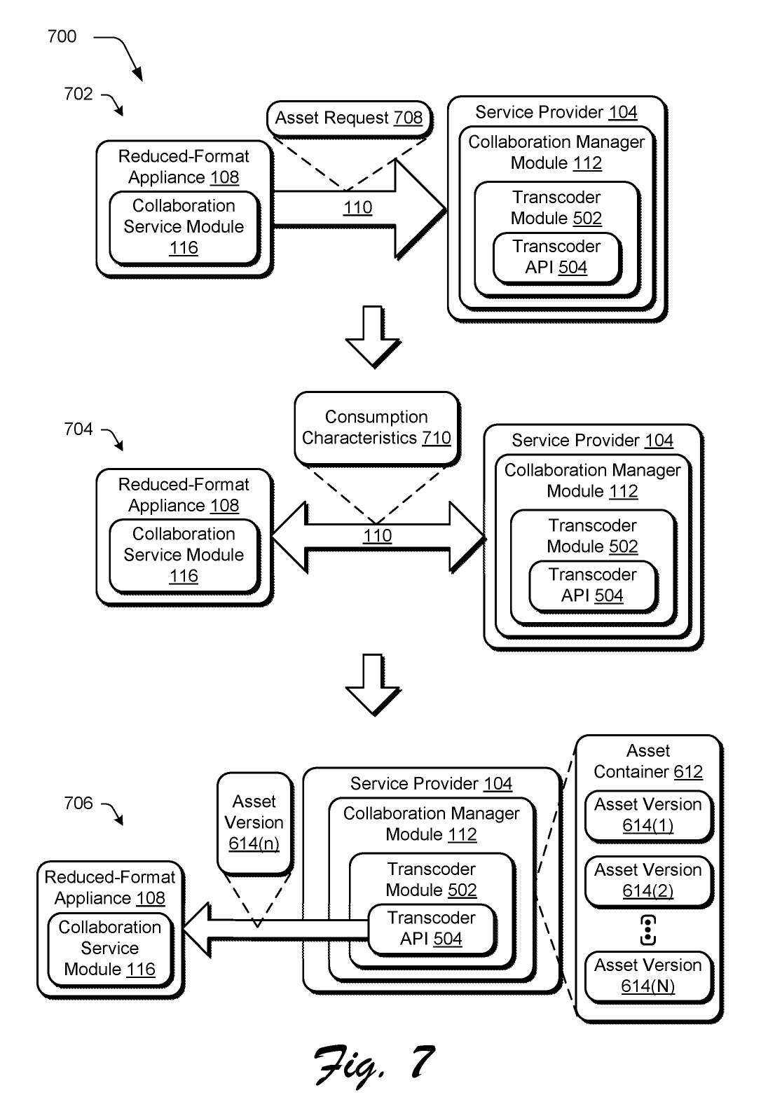

FIG. 7 depicts a system 700 in an example implementation showing distribution control of versions of content created as described in relation to FIG. 6. This example is illustrated using first, second, and third stages 702, 704, and 706, which may be performed by a variety of systems, such as the collaboration server 302 of FIG. 3. At the first stage 702, an asset request 708 is received by the service provider 104 from a reduced-format appliance 108, although any other appliance type is also contemplated. The request, for instance, may be received during a session of a shared workspace to access a particular asset, which may or may not be accessed by other appliances of the shared workspace at that time. The asset request 708 may be received via a transcoder API 504 of the transcoder module 502 or any other API or functionality of the collaboration manager module 112 usable to communicate data over a network 110.

In response, consumption characteristics 710 of the appliance to consume the requested content is determined, such as consumption characteristics of the reduced-format appliance 108 in this example. The collaboration manager module 112 and the reduced-format appliance 108, for instance, may engage in a handshaking process in which a determination is made as to capabilities of the appliance and which available versions of assets correspond to these capabilities. Examples of capabilities include hardware, software, or network capabilities to process, store, render, or communicate assets. For example, data received from the reduced-format appliance 108 may dictate which transformation of the asset corresponds to the appliance, such as which format is usable by a web client of the appliance (e.g., HTML5), resolutions, supported document and image formats, bandwidth of a network connection used to obtain the asset, display width and height, HTML user agent header, or any other hardware or software resources of the appliance. For example, the data may describe that the reduced-format appliance 108 has limited capabilities (e.g., reduced processing, memory, or network capabilities) and select a version of an asset that is configured to be processed, stored, or communicated based on those limitations.

At the third stage 706, an asset version 614(n) identified in the previous stage is communicated to the requesting appliance, e.g., the reduced-format appliance 108 in this example. The asset version 614(n) corresponds to a particular one of the plurality of asset versions 614(1)-614(N) to be consumed by functionality of the appliance as determined in the previous stage. This process may continue for other appliances that participate in the shared workspace, with versions of assets selected based on respective capabilities of those appliances. Further discussion of this and other examples may be found in relation to the following procedures.

### Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-7.

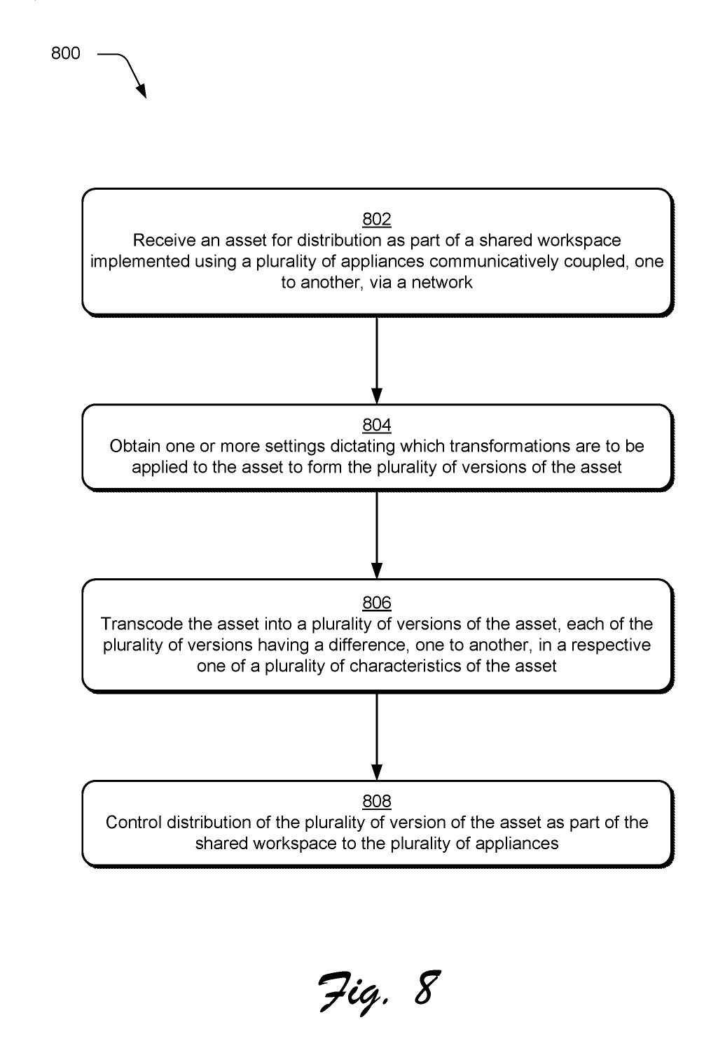

FIG. 8 depicts a procedure 800 in an example implementation in which a plurality of versions is generated of an asset shared as part of a shared workspace, virtually. An asset is received for possible distribution as part of a shared workspace that may support a plurality of appliances communicatively coupled, one to another, via a network (block 802). The asset, for instance, may be received before, after, or during a session of a shared workspace (e.g., a login session) by a service provider 104.

One or more settings are obtained that dictate which transformations are to be applied to the asset to form the plurality of versions of the asset (block 804). As shown at the second stage 604 of FIG. 6, for instance, transcode settings 610 are obtained that describe which versions and characteristics of versions that are to be generated for the asset. The characteristics, as previously described, may include image formats, resolutions, file formats, and so forth. As such, transformation applied to the assets include transformation in image format, resolutions, file formats, and so forth.

The asset is transcoded into a plurality of versions of the asset. Each of the plurality of versions has a difference, one to another, in a respective one of a plurality of characteristics of the asset (block 806). The characteristic, for instance, may include resolution, size, formatting, streaming format, layer flattening, color gamut reduction and so forth and the differences relate to these characteristics.

Distribution is controlled of the plurality of version of the asset as part of the shared workspace to the plurality of appliances (block 808). This distribution may be based on consumption characteristics of an appliance that is to consume the asset, an example of which is described in the following.

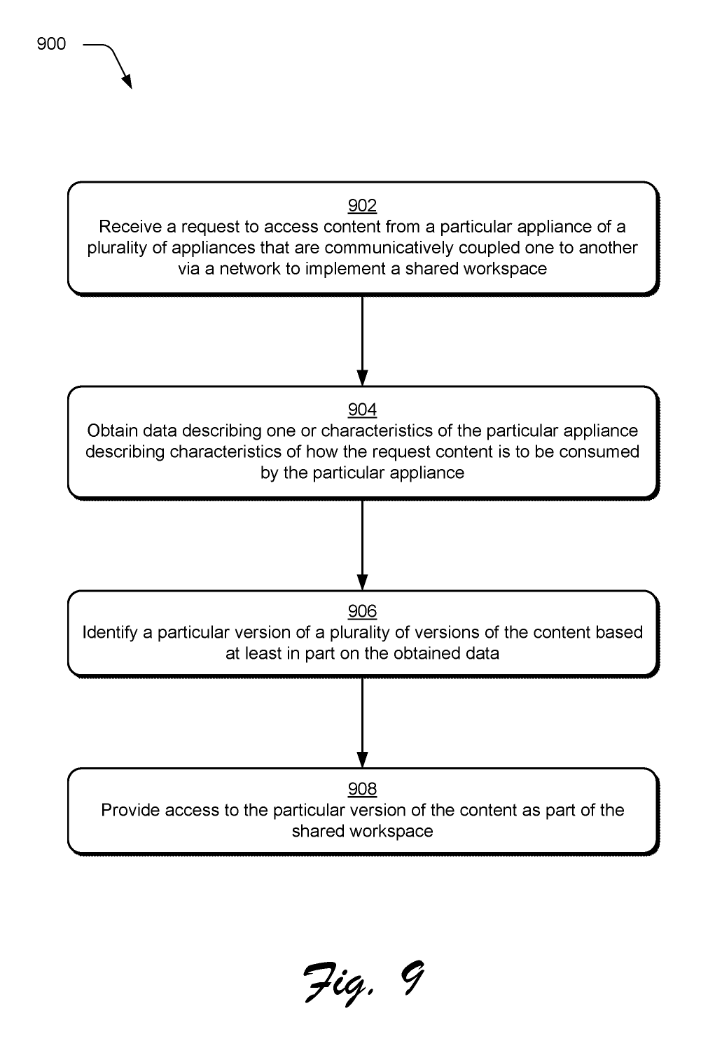

FIG. 9 depicts a procedure 900 in an example implementation in which distribution is controlled of a plurality of versions generated of an asset shared as part of a shared workspace. A request is received to access content from a particular appliance of a plurality of appliances that are communicatively coupled one to another via a network to implement a shared workspace (block 902). Large and reduced format appliances 106, 108, for instance, may participate with the service provider 104 as part of a shared workspace. The large-format appliance 106 may have provided an asset for sharing as described in relation to FIG. 8, versions of which are then generated by the service provider 104. The reduced-format appliance 108 then requests access to this asset.

Data is obtained that describes one or more characteristics of the particular appliance describing characteristics of how the request content is to be consumed by the particular appliance (block 904). The reduced-format appliance 108 may provide the data as part of the request, as part of a handshaking protocol, and so forth. This data describes characteristics of asset consumption by the reduced-format appliance 108, such as to identify an application or other software available to consume the asset, hardware functionality of the appliance (e.g., resolution, processor, memory or other hardware resources), network resources, and so forth. For example, a browser may send data that describes a width and height of a window of the browser.

A particular version is identified of a plurality of versions of the content based at least in part on the obtained data (block 906). The collaboration manager module 112 then selects a version of the asset based on these characteristics, such as a reduced format of a display device, limitations in network access (e.g., over a paid connection), and so forth.

Access is provided to the particular version of the content as part of the shared workspace (block 908). This may include streaming of the particular version of the content, sending of a notification that includes a network address via which the asset may be obtained (e.g., downloaded from), and so forth. A variety of other examples are also contemplated as described above.

### Example System and Device

FIG. 10 illustrates an example system generally at 1000 that includes an example computing device 1002 that is representative of one or more computing systems and/or devices that may implement the various techniques described herein. This is illustrated through inclusion of the collaboration service module 114 and collaboration manager module 112. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media. The memory/storage component 1012 may include volatile media (such as random access memory (RAM)) and/or nonvolatile media (such as read only memory (ROM), Flash memory, optical disks, magnetic disks, and so forth). The memory/storage component 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 may include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 may abstract resources and functions to connect the computing device 1002 with other computing devices. The platform 1016 may also serve to abstract scaling of resources to provide a corresponding level of scale to encountered demand for the resources 1018 that are implemented via the platform 1016. Accordingly, in an interconnected device embodiment, implementation of functionality described herein may be distributed throughout the system 1000. For example, the functionality may be implemented in part on the computing device 1002 as well as via the platform 1016 that abstracts the functionality of the cloud 1014.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by one or more computing devices, an asset for distribution as part of a shared workspace implemented using a plurality of appliances communicatively coupled, one to another, via a network;
responsive to the receiving by the one or more computing devices, transcoding the asset into a plurality of versions of the asset, each of the plurality of versions having a difference, one to another, in a respective one of a plurality of characteristics of the asset; and
controlling, by the one or more computing device, distribution of the plurality of versions of the asset as part of the shared workspace to the plurality of appliances.

2. The method as described in claim 1, wherein:
the plurality of versions of the assets each have a different resolution, one to another;
a first said appliance includes a display device having resolution greater than a resolution of a display device of a second said appliance; and
the controlling includes distributing a first said version of the asset to a first said appliance and distributing a second said version of the asset to a second said appliance, the first said version having a resolution greater than a resolution of a second said version of the asset.

3. The method as described in claim 1, wherein the controlling of the distribution to at least one of the plurality of appliances includes communicating at least one said version of the asset to the at least one said appliance responsive to interaction with the at least asset as part of the shared workspace.

4. The method as described in claim 1, wherein the controlling of the distribution to at least one of the plurality of appliances includes communicating at least one said version of the asset to the at least one said appliance responsive to joining of the at least one said appliance to the shared workspace

5. The method as described in claim 1, wherein the plurality of characteristics include resolution, image format, document format, or streaming format.

6. The method as described in claim 2, wherein each of the plurality of resolutions are categorized by a respective one of a plurality of widths in pixels.

7. The method as described in claim 1, wherein the receiving is performed via an application programming interface.

8. The method as described in claim 1, further comprising responsive to the receiving, obtaining one or more settings by the one or more computing devices, the one or more settings dictating which transformation is to be applied to the respective characteristic of the asset to form the plurality of versions of the asset.

9. The method as described in claim 1, wherein the controlling includes obtaining data from a particular one of the plurality of appliances requesting access to the asset that is usable to determine which of the plurality of versions are to be provided to the particular said appliance.

10. The method as described in claim 6, wherein the data describes display width and height of the particular said appliance, bandwidth of a connection to the network available to the particular said appliance, or HTML user agent header.

11. A method comprising:
receiving, by one or more computing devices, a request to access content from a particular appliance of a plurality of appliances that are communicatively coupled one to another via a network to implement a shared workspace;
obtaining, by one or more computing devices, data describing one or characteristics of the particular appliance describing characteristics of how the request content is to be consumed by the particular appliance;
identifying, by the one or more computing devices, a particular version of a plurality of versions of the content based at least in part on the obtained data; and
providing, by the one or more computing devices, access to the particular version of the content as part of the shared workspace.

12. The method as described in claim 11, wherein the data describes display width and height of the particular said appliance, bandwidth of a connection to the network available to the particular said appliance, or HTML user agent header.

13. The method as described in claim 11, wherein:
the plurality of versions of the assets each have a different resolution, one to another;
a first said appliance includes a display device having resolution greater than a resolution of a display device of a second said appliance; and
the providing includes distributing a first said version of the asset to a first said appliance and distributing a second said version of the asset to a second said appliance, the first said version having a resolution greater than a resolution of a second said version of the asset.

14. The method as described in claim 11, wherein the providing of the access includes communicating at least one said version of the asset to at least one said appliance responsive to interaction with the at least asset as part of the shared workspace.

15. The method as described in claim 11, wherein the controlling of the distribution to at least one of the plurality of appliances includes communicating at least one said version of the asset to at least one said appliance responsive to joining of the at least one said appliance to the shared workspace

16. A system comprising:
a collaboration manager module implemented at least partially in hardware to receive an asset for distribution as part of a shared workspace implemented using a plurality of appliances communicatively coupled, one to another, via a network; and
a transcoder module implemented at least partially in hardware to transcode the asset into a plurality of versions of the asset, each of the plurality of versions having a difference, one to another, in a respective one of a plurality of characteristics of the asset.

17. The system as described in claim 16, wherein the plurality of characteristics include resolution, image format, document format, or streaming format.

18. The system as described in claim 16, wherein each of the plurality of resolutions are categorized by a respective one of a plurality of widths in pixels.

19. The system as described in claim 16, wherein the asset is received by the collaboration manager module via an application programming interface.

20. The system as described in claim 16, wherein the transcoder module is configured to obtain one or more settings, the one or more settings dictating which transformations are to be applied to the asset to form the plurality of versions of the asset.
